(19) United States
(12) Patent Application Publication
(10) Pub. No.: US 2011/0143200 A1
(43) Pub. Date: Jun. 16, 2011

(54) METHOD OF MANUFACTURING CATHODE ACTIVE MATERIAL FOR LITHIUM SECONDARY BATTERY AND 1-D NANOCLUSTER CATHODE ACTIVE MATERIAL WITH CHESTNUT TYPE MORPHOLOGY OBTAINED BY THE METHOD

(75) Inventors: Young Gi Lee, Daejeon (KR); Min Gyu Choi, Daejeon (KR); Kwang Man Kim, Daejeon (KR); Jae Phil Cho, Ulsan (KR)

(73) Assignees: Electronics and Telecommunications Research Institute, Daejeon (KR); Ulsan National Institute Science and Technology Academy-Industry Research Cooperation, Ulsan (KR)

(21) Appl. No.: 12/878,642

(22) Filed: Sep. 9, 2010

(30) Foreign Application Priority Data
Dec. 14, 2009 (KR) 10-2009-0124013

(51) Int. Cl. H01M 4/48; B05D 5/12

(52) U.S. Cl. 429/218.1; 427/77; 977/832

(57) ABSTRACT

Provided are a method of manufacturing a cathode active material for a lithium battery, and a cathode active material obtained by the method. The method includes forming a precursor of a one-dimensional nanocluster manganese dioxide with a chestnut-type morphology, inserting lithium into the formed precursor and synthesizing a one-dimensional nanocluster cathode active material particle with a chestnut morphology, coating a water-soluble polymer on a surface of the cathode active material particle, adsorbing a metal ion to the surface of the cathode active material particle coated with the water-soluble polymer, and sintering the cathode active material particle to obtain the one-dimensional nanocluster cathode active material with a chestnut morphology. The cathode active material manufactured by the above method is a one-dimensional nanocluster with a chestnut-type morphology, which has a uniform-thick metal oxide layer on its surface, thereby ensuring an improved capacity of the cathode active material and an excellent cycle characteristic.

### CROSS-REFERENCE TO RELATED APPLICATION

This application claims priority to and the benefit of Korean Patent Application No. 10-2009-0124013, filed Dec. 14, 2009, the disclosure of which is incorporated herein by reference in its entirety.

### BACKGROUND

1. Field of the Invention

The present invention relates to a method of manufacturing a cathode active material for a lithium secondary battery and a cathode active material obtained by the method. More particularly, the present invention relates to a method of manufacturing a cathode active material for a lithium secondary battery in which a coating layer is uniformly formed on a surface of the one-dimensional nanocluster cathode active material with a chestnut-type morphology and a one-dimensional nanocluster cathode active material with a chestnut-type morphology obtained by the method.

2. Discussion of Related Art

A spinel type lithium manganese oxide (LiMn₂O₄) is actively being researched as a cathode active material for a lithium secondary battery. However, such a spinel type oxide is low in high rate charging/discharging and high power characteristics, and lithium-released Li₀Mn₂O₄(λ-MnO₂) is changed in structure by a reaction with an electrolyte at high temperature.

For example, a material containing a manganese ion (Mn²⁺) is molten out of a surface of a lithium manganese oxide (LiMn₂O₄) electrode by a reaction with an electrolyte, and thus the capacity of a 4 V lithium/lithium manganese oxide (Li/LiₓMn₂O₄) battery is reduced.

When Li₁₊ₓMn₂₋ₓO₄ spinel is used at 55° C., the release of Mn is prevented, thereby reducing capacity reduction, but an initial capacity is small. To exhibit a stable cycle characteristic by minimizing the release of manganese (Mn) of LiMn₂O₄ at a temperature of 50° C. or more, it is most important to control reactivity between an electrolyte and a spinel surface.

Thus, surface coating is suggested as a conventional method of minimizing the release of manganese, but according to this method, a coating layer is not formed to have a uniform thickness, and thus manganese is likely to be released from a thinner part of the coating layer.

As the cathode active material is reduced to a nanometer size, the high power characteristic is improved, but it is more difficult to control the surface reactivity and form the coating layer to have a uniform thickness to prevent the surface reactivity.

### SUMMARY OF THE INVENTION

The present invention is directed to a method of manufacturing a cathode active material for a lithium secondary battery by which a one-dimensional nanocluster cathode active material with a chestnut-type morphology can be manufactured, capable of satisfying both high-energy density and high power characteristics of an electrode, and preventing various electrochemical side-reactions and release of the active material by forming a uniform coating layer on a surface of the cathode active material.

The present invention is also directed to a one-dimensional nanocluster cathode active material with a chestnut-type morphology having a uniform coating layer capable of satisfying both high-energy density and high power characteristics and preventing various electrochemical side-reactions and release of an active material.

One aspect of the present invention provides a method of manufacturing a one-dimensional nanocluster cathode active material with a chestnut-type morphology, including: forming a precursor of a one-dimensional nanocluster manganese dioxide with a chestnut-type morphology; inserting lithium into the formed precursor and synthesizing a one-dimensional dimensional nanocluster cathode active material particle with a chestnut morphology; coating a water-soluble polymer on a surface of the cathode active material particle; adsorbing a metal ion to the surface of the cathode active material particles coated with the water-soluble polymer; and sintering the cathode active material particle to obtain the one-dimensional nanocluster manganese dioxide with a chestnut-type morphology.

In the method of manufacturing a cathode active material according to the present invention, the manganese dioxide precursor may have an a-crystalline structure manufactured by a hydrothermal synthesizing method, and specifically, may be α-MnO₂ formed by reacting manganese (II) sulfate pentahydrate with ammonium persulfate in distilled water.

In the method of manufacturing a cathode active material according to the present invention, the cathode active material particle may be LiMnₓNi₂₋ₓO₄ (x=2 to 0.1) synthesized by reacting the manganese dioxide precursor in lithium acetate or a mixed solution of lithium acetate and Ni(NO₃)₂·6H₂O, and the synthesized cathode active material particle may have a particle size of 500 nm to 50 μm.

In the method of manufacturing a cathode active material according to the present invention, coating with the water-soluble polymer may include dissolving a water-soluble polymer in water and adding the synthesized cathode active material particle in the water in which the water-soluable polymer is dissolved, and coating the water-soluble polymer on a surface of the cathode active material particle. Here, the water-soluble polymer may include at least one selected from the group consisting of polyvinyl pyrrolidone (PVP), polyethylene oxide (PEO), carboxymethyl cellulose (CMC), polyvinyl alcohol (PVA), polyether imide (PEI) and polyvinyl acetate (PVAc).

In the method of manufacturing a cathode active material according to the present invention, the adsorption of a metal ion on the surface of the cathode active material particles coated with the water-soluble polymer may include: ionizing a metal compound in water; and selectively adsorbing the ionized metal ion to the surface of the cathode active material particle coated with the water-soluble polymer. Here, the metal compound may include at least one selected from the group consisting of magnesium oxalate, zinc oxalate, and aluminum nitrate.

The method may further include, after the adsorption of the metal ion, filtering and drying the cathode active material particle.

In the method of manufacturing a cathode active material according to the present invention, the sintering may be carried out at 500 to 700° C. for 2 to 5 hours.

Another aspect of the present invention provides a one-dimensional nanocluster cathode active material with a chestnut-type morphology including a metal oxide coating layer on a surface of the cathode active material particle manufactured by a method including: forming a precursor of a one-dimensional nanocluster manganese dioxide with a chestnut-type morphology; inserting lithium into the formed precursor and synthesizing a one-dimensional nanocluster cathode active material particle with a chestnut morphology; coating a water-soluble polymer on a surface of the cathode active material particle; adsorbing a metal ion to the surface of the cathode active material coated with the water-soluble polymer; and sintering the cathode active material particle to obtain the one-dimensional nanocluster cathode active material with a chestnut-type morphology.

The cathode active material particles according to the present invention may have a diameter of 500 nm to 50 μm, and the metal oxide coating layer may have a thickness of 1 to 25 nm.

### BRIEF DESCRIPTION OF THE DRAWINGS

The above and other objects, features and advantages of the present invention will become more apparent to those of ordinary skill in the art by describing in detail preferred embodiments thereof with reference to the attached drawings in which:

FIG. 1 is a flowchart illustrating a method of manufacturing a one-dimensional nanocluster cathode active material with a chestnut-type morphology according to an exemplary embodiment of the present invention;

FIG. 2 is a schematic flowchart illustrating a change in shape of a cathode active material manufactured according to the manufacturing method according to the present invention;

FIG. 3 is a diagram of a one-dimensional nanocluster cathode active material with a chestnut-type morphology according to an exemplary embodiment of the present invention;

FIGS. 4A and 4B show SEM photographs of a precursor of a cathode active material with a chestnut-type morphologya —MnO₂, and an XRD result for a —MnO₂, respectively;

FIG. 5 is an SEM photograph of a one-dimensional nanocluster cathode active material particle, LiMn₂O₄, finally obtained after thermally treating the precursor of the cathode active material of FIG. 4;

FIG. 6 shows graphs of charging/discharging results of batteries having cathode active material powder manufactured in exemplary embodiments of the present invention; and

FIG. 7 shows cycle characteristics of batteries having cathode active material powder manufactured in the exemplary embodiments of the present invention at 50° C.

### DETAILED DESCRIPTION OF EXEMPLARY EMBODIMENTS

Hereinafter, the present invention will be described with reference to the accompanying drawings in detail. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout the specification. In the drawings, the thickness of layers and regions are exaggerated for clarity.

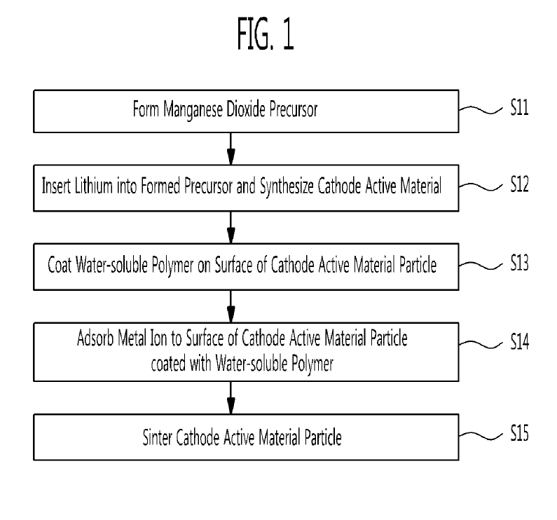

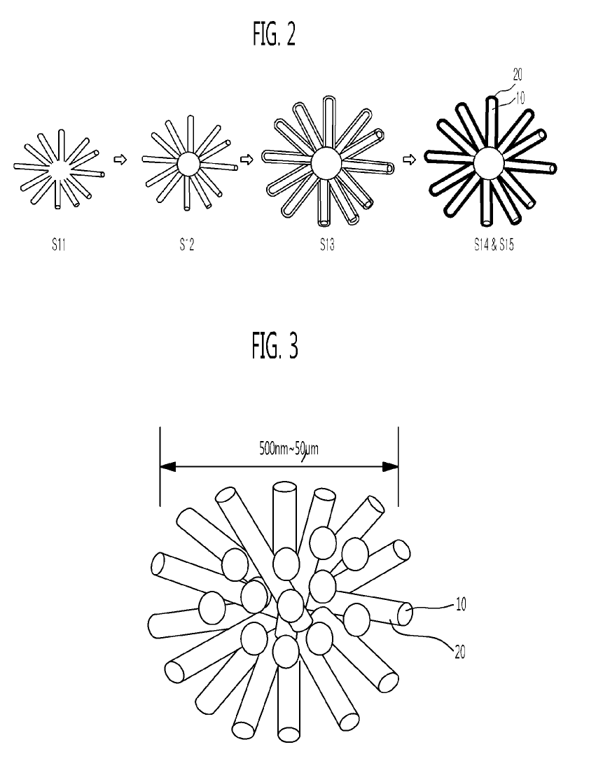

FIG. 1 is a flowchart illustrating a method of manufacturing a one-dimensional nanocluster cathode active material with a chestnut-type morphology according to an exemplary embodiment of the present invention, and FIG. 2 is a flowchart illustrating a change in shape of a cathode active material manufactured according to the manufacturing method according to the present invention.

Referring to FIGS. 1 and 2, the method includes: forming a precursor of a one-dimensional nanocluster manganese dioxide with a chestnut-type morphology (S11); inserting lithium into the formed precursor and synthesizing a one-dimensional nanocluster cathode material particle with a chestnut-type morphology (S12); coating a water-soluble polymer on a surface of the cathode active material particle (S13); adsorbing a metal ion to the surface of the cathode active material particle coated with the water-soluble polymer (S14); and sintering the cathode active material particle (S15) to obtain the one-dimensional nanocluster cathode active material with a chestnut-type morphology.

In operation S11, the manganese dioxide precursor may be manufactured by a hydrothermal synthesizing method and have an α-crystalline structure. Specifically, manganese (II) sulfate pentahydrate (MnSO₄·5H₂O) reacts with ammonium persulfate ((NH₄)₂S₅O₈) in water at 100 to 140° C. for 10 to 14 hours, thereby forming a precursor for a one-dimensional nanocluster cathode active material with a chestnut-type morphology, manganese dioxide precursor (α-MnO₂). In this case, the manganese (II) sulfate pentahydrate and the ammonium persulfate may be reacted in a molar ratio of approximately 1:1, and the reaction may be carried out in an autoclave.

In operation S12, the one-dimensional nanocluster cathode active material particle with a chestnut-type morphology (LiMnₓNi₂₋ₓO₄ (x=2 to 0.1)) is manufactured by thermal treatment at 600 to 800° C. for 5 to 10 hours using lithium acetate to insert lithium or using a mixture of lithium acetate and Ni(NO₃)₂·6H₂O to insert lithium and nickel into the manganese dioxide precursor obtained in the previous operation. The manufactured cathode active material powder particle may be spinel-type lithium manganese oxide (LiMn₂O₄).

Operation S13 includes dissolving the water-soluble polymer in water, and adding the synthesized cathode active material particle to the water in which water-soluble polymer is dissolved to coat the water-soluble polymer on the surface of the cathode active material particle.

The water-soluble polymer may be at least one selected from the group consisting of polyvinyl pyrrolidone (PVP), polyethylene oxide (PEO), carboxymethyl cellulose (CMC), polyvinyl alcohol (PVA), polyether imide (PEI) and polyvinyl acetate (PVAc). The water-soluble polymer may be dissolved in the water to a content of 0.1 to 10 wt % based on the total weight of the cathode active material particle.

When the cathode active material particle is added to the water (e.g., distilled water) in which the water-soluble polymer is dissolved, and then is stirred and maintained, the dissolved water-soluble polymer is coated on the surface of the cathode active material powder particle. The stirring may be carried out at room temperature for 6 to 12 hours, and the maintenance may last for approximately 5 to 30 minutes at approximately 30 to 50° C.

Operation S14 includes ionizing a metal compound in water, and selectively adsorbing an ionized metal ion to a surface of the cathode active material particle coated with the water-soluble polymer.

The metal compound may be dissociated into ions in water (e.g., distilled water), such as magnesium oxide, zinc oxide or aluminum nitride. The metal compound is dissociated into a metal ion and an ion not containing metal in water. That is, magnesium oxalate (MgC₂O₄) may be dissociated into Mg²⁺ and C₂O₄²⁻, and aluminum nitride (Al(NO₃)₃) may be dissociated into Al³⁺ and NO₃⁻.

The dissociated metal ion is chemically adsorbed to the surface of the cathode active material particle coated with the water-soluble polymer.

An input of the metal compound may be regulated for the weight of a metal oxide to be formed in a subsequent process to be in the range of approximately 0.1 to 5 wt % based on the total weight of the cathode active material particle.

Subsequently, the cathode active material particle coated with the water-soluble polymer to which the metal ion is adsorbed may be subjected to filtration and drying.

Operation S15 may be carried out at 500 to 700° C. for 2 to 5 hours. During sintering, a remaining water-soluble polymer which is not coated on the surface of the cathode active material particle burns out, and a metal oxide is formed by oxygen bound to the metal atom. Then, a coating layer is formed by binding the metal oxide to the water-soluble polymer by carbonation.

The coating layer may be formed to a thickness of 1 to 25 nm. When the thickness of the coating layer is less than 1 nm, it is difficult to provide an efficient coating effect since it is too thin, and when the thickness of the coating layer is larger than 25 nm, a lithium ion of the cathode active material particle is difficult to move to the outside since it is too thick.

The cathode active material manufactured according to the above manner, as shown in FIG. 3 includes a one-dimensional nanocluster cathode active material particle 10 with a chestnut-type morphology and a metal oxide coating layer 20 covering the surface of the cathode active material particle. The cathode active material particle has a diameter of approximately 50 nm to 50 nm, and the coating layer 20 covering the cathode active material particle has a thickness of 1 to 25 nm.

### EXAMPLE 1

Formation of One-Dimensional Nanocluster LiMn₂O₄ with Chestnut-type Morphology and MgO Coating Layer

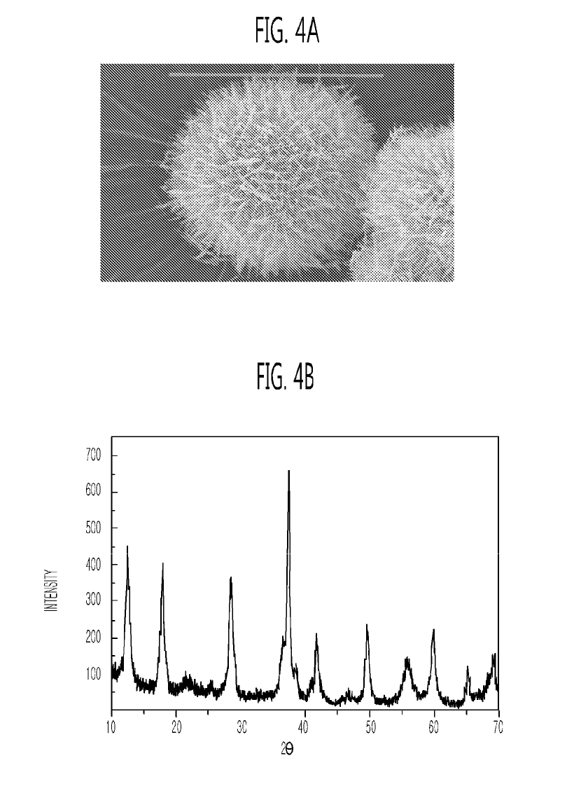

0.09598 mol MnSO₄·H₂O was completely dissolved in 100 ml of distilled water, and 0.09598 mol (NH₄)₂S₂O₈ was added and dissolved completely. The dissolved solution was poured in an autoclave container, and was subjected to reaction at 120° C. for 12 hours under a high pressure. After the synthesis was completed, precipitated particles were washed with distilled water five times, and were dried in an oven over 120° C. for 24 hours. The particles obtained after drying were identified as α-MnO₂ particles with a chestnut morphology through SEM and XRD structural analyses (see FIGS. 4A and 4B).

0.069 mol of a precursor of a one-dimensional nanocluster cathode active material with a chestnut-type morphology, MnO₂, was added to 50 ml of distilled water in which 0.0345 mol Li(CH₃COO)₂·H₂O was completely dissolved and then was stirred. Afterwards, the resulting mixture was filtered and dried at 120° C., and then the dried product was grinded using a mortar. Subsequently, the grinded result was subjected to primary thermal treatment at 400° C. for 2 hours. The resulting powder was ground again using a mortar, and was subjected to secondary thermal treatment at 700° C. for 8 hours to obtain powder particle of lithium manganese oxide (LiMn₂O₄) with a chestnut-type morphology. It was identified that the powder particle has a chestnut-type morphology through SEM structural analysis (see FIG. 5).

Subsequently, polyvinyl pyrrolidone (PVP) was dissolved in distilled water, the above lithium manganese oxide powder particle was added thereto, and then they were stirred. The PVP was added to an amount of 1 wt % based on the total weight of the lithium manganese oxide powder particle. The distilled water containing the powder particle was maintained at 40° C. for 10 minutes, and MgC₂O₄ was added thereto for coating with metal oxide. The MgC₂O₄ was added such that the weight of MgO to be formed in a subsequent process becomes 1 wt % based on the total weight of the lithium manganese oxide powder particle. The lithium manganese oxide powder particle was filtered and dried. After the filtration and drying, the lithium manganese oxide powder particle was subjected to sintering, which was carried out at 600° C. for 3 hours. Thereby, remaining PVP was burned out to be removed, and a MgO coating layer bound to a carbon layer formed by carbonation of MgO and PVP was formed on the surface of the lithium manganese oxide powder particle.

### EXAMPLE 2

A process was the same as that described in Example 1, except that an Al₂O₃-PVP coating layer was formed using Al(NO₃)₃ instead of MgC₂O₄ for coating with metal oxide. An input of Al(NO₃)₃ added for the metal oxide coating was regulated such that the weight of Al₂O₃ to be formed in a subsequent process becomes 1 wt % based on the total weight of the lithium manganese oxide powder particle.

### COMPARATIVE EXAMPLE

### Formation of MgO Coating Layer

For comparison, an experiment to form a MgO-binding coating layer on nano-sized spherical spinel-type lithium manganese oxide (LIMn₂O₄) powder was conducted. Specifically, lithium manganese oxide powder and MgC₂O₄ were added to distilled water and then were stirred. An input of the MgC₂O₄ was regulated such that the weight of MgO to be formed in a subsequent process becomes 1 wt % based on the total weight of the lithium manganese oxide powder. The lithium manganese oxide powder was filtered and dried. After the filtration and drying, the lithium manganese oxide powder was subjected to sintering, which was carried out at 600° C. for 3 hours.

Thereby, a MgO coating layer was formed on a surface of the lithium manganese oxide powder particle.

### EXAMPLE 4

### Manufacture of Battery

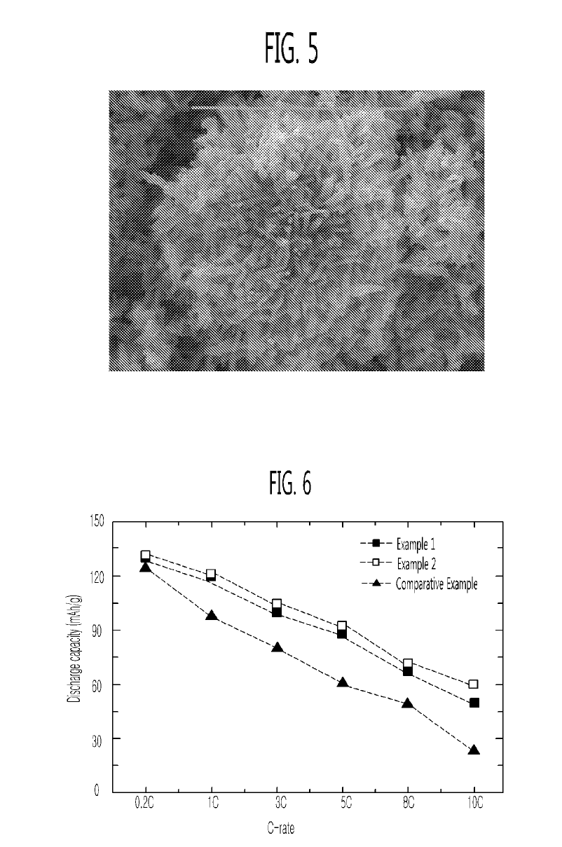

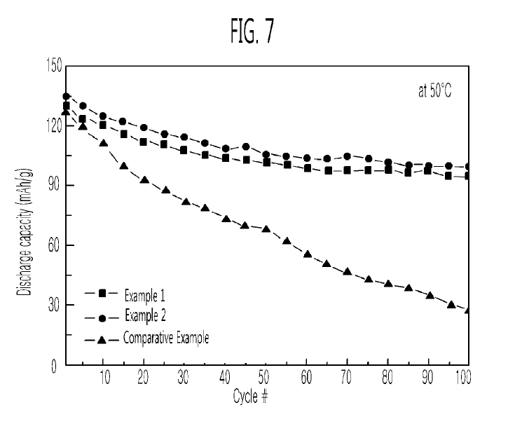

Batteries were manufactured using the active material powder manufactured in Examples 1 and 2 and the lithium manganese oxide powder manufactured in Comparative Example. Specifically, to each powder, a polyvinylidenefluoride binder, super P carbon black, and N-methylpyrrolidone (NMP) solution were added and mixed, thereby obtaining a mixture. The mixture was coated on aluminum foil to manufacture an electrode plate. The electrode plate was used as a cathode, and lithium metal was used as an anode, thereby manufacturing a pouch-type cell having a size of 2 cm×2 cm. As an electrolyte, a mixed solution (1/1 volume ratio) of ethylene carbonate (EC) and dimethyl carbonate (DMC) in which 1M LiPF₆ was dissolved was used. Each cell (battery) including the lithium manganese oxide powder was subjected to a charging/discharging experiment at a voltage of 3 to 4.5 V. The results are shown in FIGS. 6 and 7.

From the results of FIG. 6, compared to Comparative Example, Examples 1 and 2 can exhibit excellent initial capacity and discharging capacity according to an increase in current. Such results indicate that the one-dimensional nanocluster cathode active material with a chestnut morphology have excellent power and energy density characteristic.

From the results of FIG. 7, compared to Comparative Example, Examples 1 and 2 can exhibit excellent cycle performance. Such results indicate that in the one-dimensional nanocluster cathode active material with a chestnut morphology, both a side-reaction with an electrolyte and release of an active material are inhibited at high temperature.

According to a method of manufacturing a cathode active material for a lithium secondary battery according to the present invention, a metal oxide layer having a uniform thickness can be formed on a surface of a one-dimensional nanocluster cathode active material particle with a chestnut-type morphology such that the nanoparticle maintains a high power characteristic and behaves as a microparticle. In addition, a surface reaction according to an increase in surface area and release of an active material may be prevented, and thereby a capacity of the cathode active material can be increased, and an excellent life cycle characteristic can be ensured.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of manufacturing a one-dimensional nanocluster cathode active material with a chestnut-type morphology, comprising:
forming a precursor of a one-dimensional nanocluster manganese dioxide with a chestnut-type morphology;
inserting lithium into the formed precursor and synthesizing a one-dimensional nanocluster cathode active material particle with a chestnut morphology;
coating a water-soluble polymer on a surface of the cathode active material particle;
adsorbing a metal ion to the surface of the cathode active material particle coated with the water-soluble polymer; and
sintering the cathode active material particle to obtain the one-dimensional nanocluster cathode active material with a chestnut-type morphology.

2. The method according to claim 1, wherein the manganese dioxide precursor has an a-crystalline structure manufactured by a hydrothermal synthesizing method.

3. The method according to claim 1, wherein the manganese dioxide precursor is α-MnO₂ formed by reacting manganese (II) sulfate pentahydrate with ammonium persulfate in distilled water.

4. The method according to claim 1, wherein the cathode active material particle is LiMnₓNi₂₋ₓO₄ (x=2 to 0.1) synthesized by reacting the manganese dioxide precursor in lithium acetate or a mixed solution of lithium acetate and Ni(NO₃)₂·6H₂O.

5. The method according to claim 4, wherein the synthesized cathode active material particle has a particle size of 500 nm to 50 μm.

6. The method according to claim 1, wherein coating with the water-soluble polymer includes:
dissolving a water-soluble polymer in water; and
adding the synthesized cathode active material particle to the water in which the water-soluble polymer is dissolved, and coating the water-soluble polymer on a surface of the cathode active material particle.

7. The method according to claim 6, wherein the water-soluble polymer includes at least one selected from the group consisting of polyvinyl pyrrolidone (PVP), polyethylene oxide (PEO), carboxymethyl cellulose (CMC), polyvinyl alcohol (PVA), polyether imide (PEI) and polyvinyl acetate (PVAc).

8. The method according to claim 1, wherein the adsorption of a metal ion on the surface of the cathode active material particle coated with the water-soluble polymer includes:
ionizing a metal compound in water; and
selectively adsorbing the ionized metal ion to the surface of the cathode active material particle coated with the water-soluble polymer.

9. The method according to claim 8, wherein the metal compound includes at least one selected from the group consisting of magnesium oxalate, zinc oxalate, and aluminum nitrate.

10. The method according to claim 1, further comprising filtering and drying the cathode active material particle after the adsorption of the metal ion.

11. The method according to claim 1, wherein the sintering is carried out at 500 to 700° C. for 2 to 5 hours.

12. A one-dimensional nanocluster cathode active material with a chestnut-type morphology including a metal oxide coating layer on a surface of the cathode active material particle manufactured according to claim 1.

13. The cathode active material according to claim 12, wherein the cathode active material particle has a diameter of 500 nm to 50 μm.

14. The cathode active material according to claim 12, wherein the metal oxide coating layer has a thickness of 1 to 25 nm.
